(19) United States
(12) Patent Application Publication
(10) Pub. No.: US 2014/0026940 A1
(43) Pub. Date: Jan. 30, 2014

(54) ENERGY GENERATION SYSTEM

(71) Applicants: Juan P. ALONSO SALMERON, Madrid (ES); Ivan ARKIPOFF, Madrid (ES); Ryan BOGART, San Francisco, CA (US); Michael FRAENKEL, San Francisco, CA (US); Mark MOORE, Richmond, CA (US); Mark SCHROEDER, Cordova, CA (US); Sean R. Du Fosee, Fair Oaks, CA (US)

(72) Inventors: Juan P. ALONSO SALMERON, Madrid (ES); Ivan ARKIPOFF, Madrid (ES); Ryan BOGART, San Francisco, CA (US); Michael FRAENKEL, San Francisco, CA (US); Mark MOORE, Richmond, CA (US); Mark SCHROEDER, Cordova, CA (US); Sean R. Du Fosee, Fair Oaks, CA (US)

(73) Assignee: PV Hardware LLC, Carmichael, CA (US)

(21) Appl. No.: 13/562,165

(22) Filed: Jul. 30, 2012

(51) Int. Cl. H01L 31/052; H01L 31/18

(52) U.S. Cl. CPC H01L 31/0522; H01L 31/18
USPC 136/246; 29/890.033

(57) ABSTRACT

A system is disclosed that can include an array of solar panels. The array can be arranged into rows of linearly organized modules. The modules can be tilted by a linear actuator attached to a linkage. The tilting can be controlled to maintain a perpendicular orientation between the face of the solar panels (modules) and the direction to the sun.

### BACKGROUND

1. Field of the Invention

A system for mounting photovoltaic solar panels and more particularly, to a mounting support system that drives a number of rows of solar panels to track the motion of the sun relative to the earth is disclosed. More particularly, systems are disclosed that are directed to reliability and ease of installation of the tracker arrangement for tilting a group or array of rows of solar panels. The systems can include or be used with solar collectors in which the panels are arrays of photovoltaic cells for generation of electrical power, though the system can also include or be used with arrangements for solar energy concentration, for example.

2. Description of the Related Art

Solar photovoltaic (PV) cells convert light directly into electricity. By utilizing the most abundant, renewable energy available on the planet, namely the sun's rays, PV cells can provide a non-polluting source of electrical energy. As global energy consumption rises the need for clean, renewable sources of power has increased tremendously. This combined with the increased costs of conventional, fossil fuel based energy sources has led to a new era where solar PV systems can generate electricity at market competitive rates on a per kilowatt-hour basis.

The rapid adoption, development and construction of PV based power plants have led to greater market opportunities for companies producing PV modules. A PV module is an assembly of solar PV cells, typically in a glass laminate which is then packaged in a frame composed of aluminum or other metal. The PV module acts as an electrical component of a system of many such modules. As many as thousands of modules are strung together electrically to form commercial arrays for the generation of many megawatts of power. The greatly expanded market for PV modules combined with federal, state and local government incentive programs as well as huge investments in production capacity has created tremendous competition among PV module manufacturers. The rapid decrease in PV module costs in combination with the desire on the part of electrical utilities to own renewable energy assets has led to a renewed focus on so-called, ‘balance of system component’ costs. These components include DC-AC inverters, electrical connection components, and the mounting systems used to hold the PV modules in place and exposed to the sun's rays.

In the case of ground based tracking systems, the mounting structures must orient the modules to the sun at a favorable degree of tilt while maintaining their structural capacity for 20 to 30 years which is the expected energy production lifetime of the PV modules. Typical tracking systems are composed of metal, usually steel or aluminum. The systems have an element that is placed in the ground or attached to large ballast blocks typically of concrete. From this post or pier the system stands in the air supporting the PV modules at a height that is appropriate to prevent ground cover, encroaching weeds, or blown up topsoil from affecting the light exposure of the modules but not so tall as to require excess building materials. The modules are then moved by mechanical linkages attached to the mounting structures that are driven in turn by ground mounted motors or hydraulic rams. The primary structural load on these systems is created by wind forces acting on the PV modules themselves. The tracking systems move the modules in a manner that causes them to catch the wind and transmit the wind forces to the structural frame. Thus great amounts of wind load can be present in a typical tracking PV system.

As PV tracking systems are deployed for larger ground-based energy plants the need to reduce the costs of the system through better engineering, reduction in total materials required and the innovative use of standardized commercial construction elements rise. The costs and time associated with actual construction of the systems is also the subject of intense scrutiny as commercial building contractors look to be more competitive in the installation and commissioning of commercial and utility based PV power systems.

The overall ease with which a PV tracking system can be delivered to the construction site, assembled, installed and finally commissioned is referred to in the PV power industry as ‘constructability’. There are many factors that play into good constructability, among them the reduction in labor hours required to assemble the system or the elimination of special trades and skills being required to complete the assembly. The elimination or reductions in special tools or expensive equipment needed are also good steps toward better constructability. Finally the ability to install the tracking systems in many types of terrain and in naturally occurring hazards such as wind, rain or snow can be the key to a suitable design for low cost, high value PV power systems.

From these requirements for good constructability it can be understood that a PV tracking system which reduces the field labor hours required to build it and that eliminates costly, highly skilled trade workers would be desirable. A tracking system that can be assembled without the use of specialized tools or expensive and difficult to place equipment, such as cranes and hoists, would also be beneficial. Furthermore a system which can be sited on uneven terrain and made level through a series of minor adjustments to both the drive linkage assemblies as well as the PV module support framing, would allow for an assembly sequence with fewer steps. And lastly a PV tracking system that has at its core a utilization of readily available components that can take advantage of already high production quantities in industry would lead to lower costs for structural elements as well as control monitoring equipment and thus be a substantial improvement over specialty componentry produced of expensive materials in small quantities.

In general terms, these systems have their photovoltaic panels in the form of rows supported on a torsion tube that serves as an axis. A tracker drive system rotates or rocks the rows to keep the panels as square to the sun as possible. Usually, the rows are arranged with their axes disposed in a north-south direction, and the tracking motor and control system gradually rotate the rows of panels throughout the day from an east-facing direction in the morning to a west-facing direction in the afternoon. The rows of panels are bought back to the east-facing orientation for the next day.

Some systems include an assembly which mounts a series of PV modules to a pivot shaft via U-shaped clamps. Some of these systems can have a reduction in total parts through the multiple uses of various elements and a stable base or support structure by means of triangular supports. However, these systems can also have a pivot shaft defined to be of a relatively small cross section and thus not be able to sustain the large torsional loads that will be present on a much larger array of PV modules loaded by the wind. The U-shaped clamps are also deficient for a larger journalled torsion tube that requires that it be threaded through the bearing assemblies. Conventional bearings in the system, which though satisfactory for a reference design case, would not be durable enough for long term, outdoor, exposed usage where continued motion is required for a span of 20 or more years.

### SUMMARY OF THE INVENTION

A solar tracking system that employs a single actuator to control multiple rows of solar panels is disclosed. A system which accommodates field unevenness and changes in pitch within the terrain is disclosed.

The system can have a solar energy collector and tracker arrangement that can have a tracker associated with at least one row of solar panels. The system can have a generally north-south oriented torque tube that can define a north-south axis of the system. The system can have an array of flat rectangular PV panels that can be attached to the torque tube with the long side of the panels crossing, for example perpendicular to, the tube. The system can have at least one foundation pier. The pier can have a footing supported in the earth. A pivot bearing assembly is affixed to the pier above its footing and the torque tube is journalled in the pivot bearing assembly. This permits the array of solar panels to be rocked on the north-south axis to follow motion of the sun relative to the earth. A torque-arm member is affixed onto the torque tube and extends downward from the height of the torque tube toward the ground. A linear drive actuator has a body portion mounted on a fixed footing of permanent materials. The linear drive actuator is located between at least two rows of PV modules oriented along a north-south axis. A drive line tube extends from both sides of the linear drive actuator in a generally east-west orientation across the PV field array. The drive line assembly is connected on either side of the linear actuator to a mid-segment beam that is attached to the linear actuator arm directly. The drive line tubes are pierced in or near their center by a connecting bolt that attaches the torque arm structure in a hinged fashion. The drive line tubes are coupled at their distal ends via a splice assembly that allows for some undulation in terrain surface. When the linear drive actuator pushes forward on the drive line assembly it is simultaneously pulling on the drive line tubes on the opposite side of the actuator assembly.

The torque tube can be square in cross section. The torque tube may be formed of two or more sections joined end to end. In such case, the distal ends of the tubes will be spliced together using a cradle and a tube insert of durable materials bolted through to capture both ends of the tube in a fixed manner. This connection splice will transfer the loads in the system effectively while still allowing for expansion in the line due to thermal changes in the material without buckling or deforming the torque tube.

The bearing assembly, or gimbal, can include a cylindrical ring formed of a durable material and designed to accept two polymer bearing sections which capture either side of a square cross section torque tube. When inserted into the ring the polymer bearings are held in place by a set screw or other mechanical attachment point to prevent shifting of the bearing elements over a long duration of use. The inserts can be formed of a high density polymer material which has lubricious qualities. This arrangement is resistant to weather phenomena, and can withstand the high loads expected with solar panels presented to the wind. This assembly also allows for easy field serviceability as the bearings may be removed laterally without unseating the torque tube from its installed location.

The linear actuator assembly can drive the multiple rows of PV panels by movement of the drive line assembly. This drive line can be continuous across the array on both sides of the mid-field mounted linear actuator.

A solar power tracking system is disclosed that can have an actuator, a drive line mechanically attached to the actuator, a first photovoltaic (PV) module, and a second PV module. The drive line can have a first drive line beam, a second drive line beam, and a first splice at least partially between the first drive line beam and the second drive line beam. The first and second PV modules can be rotatably attached to the drive line. The first splice can be positioned between the first PV module and the second PV module.

The system can have a first pier and a second pier. The piers can be laterally aligned with the respective PV modules. The first splice can be positioned between the first pier and the second pier.

The system can have a first torque arm and a second torque arm. The bottom ends of the torque arms can be attached to the respective drive line beams. The top end of the torque arms can be attached to the respective PV modules. The first splice can be between the first torque arm and the second torque arm.

The first drive line beam can be rotatable or rotatably fixed with respect to the second drive line beam about the splice. The drive line beams can move in a linear, longitudinal motion. The drive line beams can move up and down, for example, to accommodate variances during assembly. The drive line beams can be configured within the system so as not to be rotatable.

The wings of PV modules can each have an elongated structural support member extending along all or part of the length of the wing, such as the torque tube. A panel rail can cross (e.g., extend perpendicularly from) the torque tube and attach to the torque tube and one or two PV modules. The elongated structural support members can be rotatably attached to the tops of piers.

A solar power tracking system is disclosed that can have a PV module comprising an elongated structural support member, a pier, a housing, and a bearing. The bearing can be rotationally fixed to the elongated structural support member. The bearing can be made from a polymer, such as ultra-high molecular weight polyethylene. The bearing can have a bearing first portion and a bearing second portion. The bearing first portion can be unadhered to the bearing second portion. The bearing can be in the housing. The housing can be attached to the top terminal end of the pier.

A method of making a solar power tracking system is disclosed. The method includes assembling a drive line, positioning the drive line adjacent to a first PV module and a second PV module, and attaching the drive line to an actuator. Assembling the drive line can include attaching a first drive line beam to a second drive line beam at a splice. The splice can be between the first PV module and the second PV module.

The method can also include securing a first pier in the ground or in a foundation and attaching a housing to the first pier. The housing can hold a bearing. The method can include rotatably fixing the bearing to the structural support member and removing the bearing from the housing without moving the structural support member with respect to the first pier.

### BRIEF DESCRIPTION OF THE DRAWINGS

FIG. 1a is a top view of a variation of the system.

FIG. 1b illustrates a variation of close-up section A-A.

FIG. 2 is a side view of a variation of the system and the ground.

FIG. 3 illustrates a variation of drive arm plates attaching the torque arms to the drive line beam.

FIG. 4a is a bottom perspective view of a variation of the torque tube splice. The proximal (first) torque sub-tube is not shown for illustrative purposes.

FIG. 4b is a top side perspective view of a variation of the drive line splice

FIGS. 5a and 5b illustrate variations of an assembly for attaching the drive line beam to the torque tube.

FIGS. 6a and 6c illustrate variations of the gimbal assembly attached to a pier and a torque tube.

FIG. 6b illustrates the gimbal assembly, pier and torque tube of FIG. 6a with the bearing shown in an exploded view for illustrative purposes.

FIG. 7 illustrates a variation of the viscous dampener attached to a pier and a torque tube.

### DETAILED DESCRIPTION

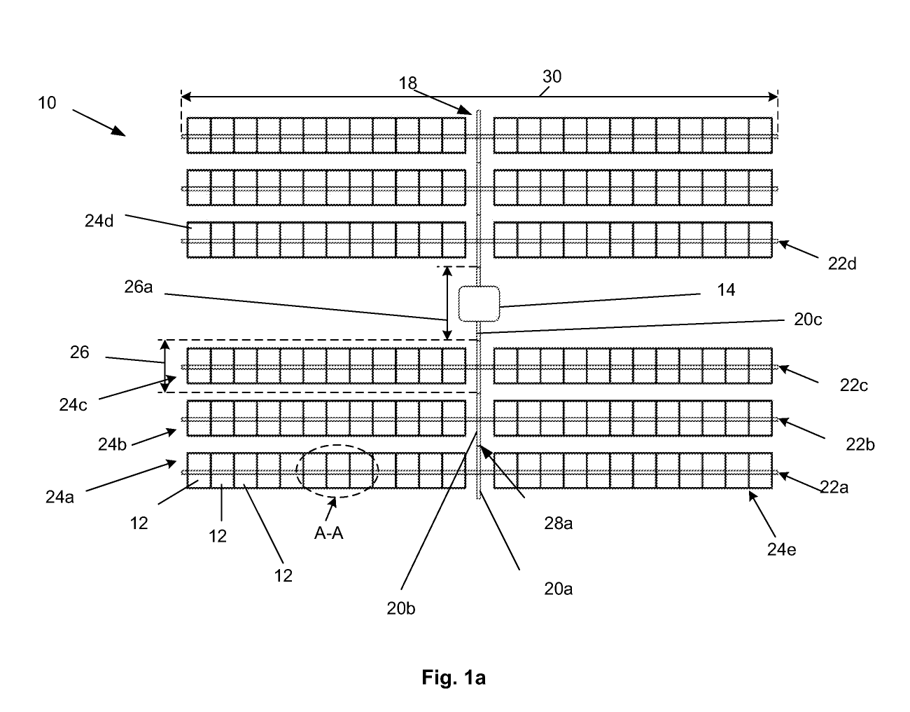

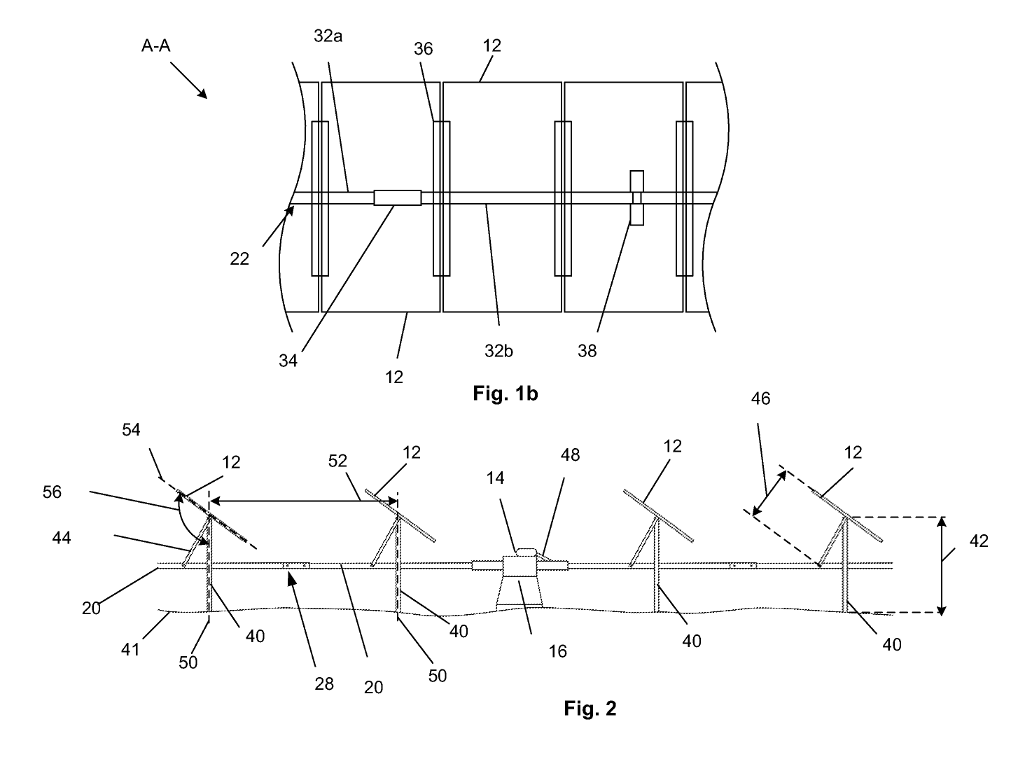

FIG. 1 illustrates that a photovoltaic (PV) or solar panel array 10 can have one or more PV modules or panels 12. Each PV module 12 can be a framed power producing PV element, such as a framed collection of solar cells. A number of the PV modules 12, for example from about 20 to about 50, more narrowly from about 24 to about 44, for example about 24 or 44, can be oriented into rows or lines. The panels 12 can be, for example, all-framed crystalline panels. The array 10 can produce, for example, from about 250 kW to about 50 MW of electrical power from the panels 12. One array 10 could produce less than 250 kw, but typically 330-500 kW per array, or “block”.

The array 10 can have a drive motor, such as a linear actuator 14, for example a ram screw. The linear actuator 14 can be located in the center of the array 10, as shown, at a terminal end of the array 10, or elsewhere within the array 10. The actuator 14 can be, for example, about a 1.5 hp to about a 5 hp, for example 1.5 hp or 5 hp, 480 V three-phase electric motor. The linear actuator 14 can be powered from electricity generated by the array 10, an external power source or combinations thereof. The linear actuator 14 can push and pull a drive line 18 through from about 24 in to about 84 in, for example about 60 in. of linear distance, for example.

The linear actuator 14 can be electronically connected to a power source and a controller. The controller can control the position of the actuator 14 dependent on the elevation position of the sun in the sky as estimated by sensors and/or by a data table based on a clock and calendar, for example to maintain the planar faces of the solar panels 12 to be perpendicularly oriented to the elevation of the sun within the limits of rotation of the panels 12. The controller can have a programmable logic control (PLC) system. The actuator 14 can be a variable frequency drive power actuator (VFD). The controller can communicate with or have a global positioning satellite (GPS) receiver and/or antennae, for example, to receive the location of the array 10 to determine the relative position of the sun in the sky.

The array 10 can have a drive line 18. The drive line can extend from or near the linear actuator 14 in one or two directions to or past the most distal module 12 in each direction from the linear actuator 14.

The drive line 18 can be made from one or more rigid drive line beams 20, for example a drive line first beam 20a and a drive line second beam 20b. One drive line beam can extend across the position of one module and/or torque tube 22. The drive line beams 20 can transmit the force from the linear actuator 14 to the modules 12 to control the angular orientation of the modules 12. The drive line 18 can be positioned in the lateral center of the rows of PV modules 12 or at a lateral end of the rows. The drive line 18 can laterally divide the rows of PV modules and attached elements into lateral wings, for example the first, second, third, and fourth west or left wings 24a, 24b, 24c, and 24d and first east or right wing 24e as shown in FIG. 1a (the remaining wings are unlabeled for illustrative purposes). The drive line 18 can extend perpendicular to the longitudinal directions of the rows or torque tubes 22 of the rows.

The drive line 18 can have one or more mid-section beams 20c that can pass through the linear actuator 14.

The drive line beams 20 can have beam lengths 26. The beam lengths 26 can be from about 7 feet to about 40 feet, for example about 20 ft. The mid-section beam 20c can have a mid-section beam length 26a. The mid-section beam length 26a can be the same as the other (i.e., not mid-section) beam lengths 26 or a different length from the rest of the drive line beams 20, for example from about 13 feet to about 52 feet, such as 26 feet.

The drive line beams 20 can be fixedly attached to adjacent drive line beams at drive line splices 28. For example, the drive line first beam 20a can be attached to the drive line second beam 20b at a drive line first splice 28a. The drive line splices 28 can be longitudinally adjustable and longitudinally fixable.

Each module can have or attach to an elongated structural support member, such as a torque tube 22. For example, first, second, third, and fourth west wings 24a, 24b, 24c, and 24d can be mounted to the first, second, third, and fourth torque tubes, 22a, 22b, 22c, and 22d respectively. The west wings and the corresponding east wings (e.g., the first west wing 24a and the first east wing 24e) can be mounted to the same torque tube (e.g., the first torque tube 22a). The torque tubes 22 can extend perpendicularly away from the drive line 18 in one or both lateral directions. The drive line 18 can intersect the lateral center of the respective torque tube 22 and/or row.

The torque tubes 22 can have a torque tube length 30 that can be from about 10 feet to about 40 feet, for example about 19 ft 3 in.

FIG. 1b illustrates that a torque tube 22 can be assembled from a number of collinear torque sub-tubes. For example, the torque tube 22 can have a torque first sub-tube 32a attached, for example at a torque tube splice 34, to a torque second sub-tube 32b. The torque tube splice 34 can rotationally and translationally fix the adjacent torque sub-tubes 32 to each other. The torque tube splices 34 can be positioned at a consistent frequency along the torque tube 22, for example from about every 4 PV modules 12 to about every 8 PV modules 12, such as at every 6.5 PV modules 12.

The arrays 10 can have panel rails 36. The panel rails 36 can cross and extend perpendicularly from the torque tubes 22. The panel rails 36 can be fixed to the torque tubes 22 and to the PV modules 12. For example, each panel rail 36 can attach to attach to lateral sides of adjacent PV modules 12. The tops of the panel rails 36 can attach to the PV modules 12. The bottoms of the panel rails 36 can attach to the torque tubes 22.

The arrays 10 can have rotating joints, such as gimbal assemblies 38, that can rotationally attach the torque tube 22 to piers 40. The gimbal assemblies 38 can cross and extend perpendicularly from the torque tubes 22. The gimbal assemblies 38 can be aligned with the piers 40. The gimbal assemblies 38 and the piers 40 can be positioned at a consistent frequency along the torque tube 22, for example from about every 3 PV modules 12 to about every 10 PV modules 12, such as at every 4.5 PV modules 12. A pier 40 and gimbal assembly 38 can be positioned at the medial and lateral terminal ends of each wing 24.

FIG. 2 illustrates that the array 10 can have piers 40. The piers 40 can have a square, rectangular, circular, oval, Omega-beam, H-beam, or I-beam cross-section, or variations thereof at different lengths along the pier 40. The piers 40 can be fixedly attached to or inserted into the ground, or attached to or inserted into concrete foundations that are fixedly attached to or inserted in the ground. The piers 40 can extend vertically above the ground surface 41 at a pier height 42. The pier height 42 can be from about 2 feet to about 8 feet, for example about 4 feet. The tops of the piers 40 in a single array can be at the same elevation or about the same elevation, for example forming a slope along the terminal top ends of the piers 40 from about 5% (2.4°) to about −5% (−2.4°), for example about 0% (0°).

The array 10 can have one or more torque arms 44. For example, each row can have one or more torque arms 44, for example one torque arm 44 can be adjacent to each gimbal assembly 38. The torque arms 44 can mechanically link the torque tubes 22 directly and, indirectly, the PV modules 12 to the drive line 18. For example, the torque arm 44 at a top end can be fixedly attached to the torque tube 22, and the torque arm 44 at a bottom end can be rotatably attached to a drive line beam 20.

The torque arm 44 can have a torque arm length 46 from about 1 feet to about 3 feet, for example about 2 feet. The torque arm length 46 can be measured from the connection with the respective drive line beam 20 (e.g., include part or all of the lengths of the drive arm plates). The torque arm lengths 46 for different torque arms 44 in the same array 10 can be equal to each other.

The linear actuator 14 can be directly fixedly attached to the ground or fixedly attached to an actuator foundation 16. The actuator foundation 16 can be fixedly attached to the ground. The actuator foundation 16 can be made from concrete and steel.

The actuator 14 can have an actuator link 48, for example extending from the remainder of the actuator 14, as shown in FIG. 2, and/or within the actuator 14, as shown in FIG. 1a. The actuator link 48 can attach the remainder of the actuator 14 to one or more drive line mid-section beams 20c.

The piers 40 can each have a pier longitudinal axis 50. Each pier longitudinal axis 50 can be parallel with a vertical line with respect to the environment or ground. The pier longitudinal axes 50 can be parallel with each other.

The length between adjacent piers 40 can be a pier gap, also referred to as row spacing 52. The pier gap or row spacing 52 can be from about 10 feet to about 50 feet, for example about 25 feet.

Each module or panel 12 can have a panel longitudinal axis 54. The panel longitudinal axis 54 can be parallel with the face of the respective panels 12.

The panel longitudinal axis 54 can intersect the pier longitudinal axis 50 at a panel-pier angle 56. The panel-pier angle 56 can be from about −45° to about 45°. When the actuator 14 is turned off or the drive line 18 or torque arm 44 is disconnected from the actuator 14, the system can be in a relaxed configuration with the panel-pier angle 56 at about 0°. (When the sun is directly above the system, the panel-pier angle can also be at about 0°.) The panel-pier angles 56 for all of the modules 12 can be synchronized with each other. The panel-pier angle 56 can be adjustable and can be changed by the controller causing the linear actuator 14 to alter the position of the drive line 18. The drive line 18 can translate and push or pull the bottom ends of the torque arms 44. The torque arms 44 can then rotate the torque tubes 22 and the modules 12.

The drive line splices 28 can be located from about 10% to about 90% of the distance from one pier 40 to the adjacent pier 40, more narrowly from about 30% to about 70%, for example about 50%. The drive line splices 28 can each be positioned between adjacent PV modules 12.

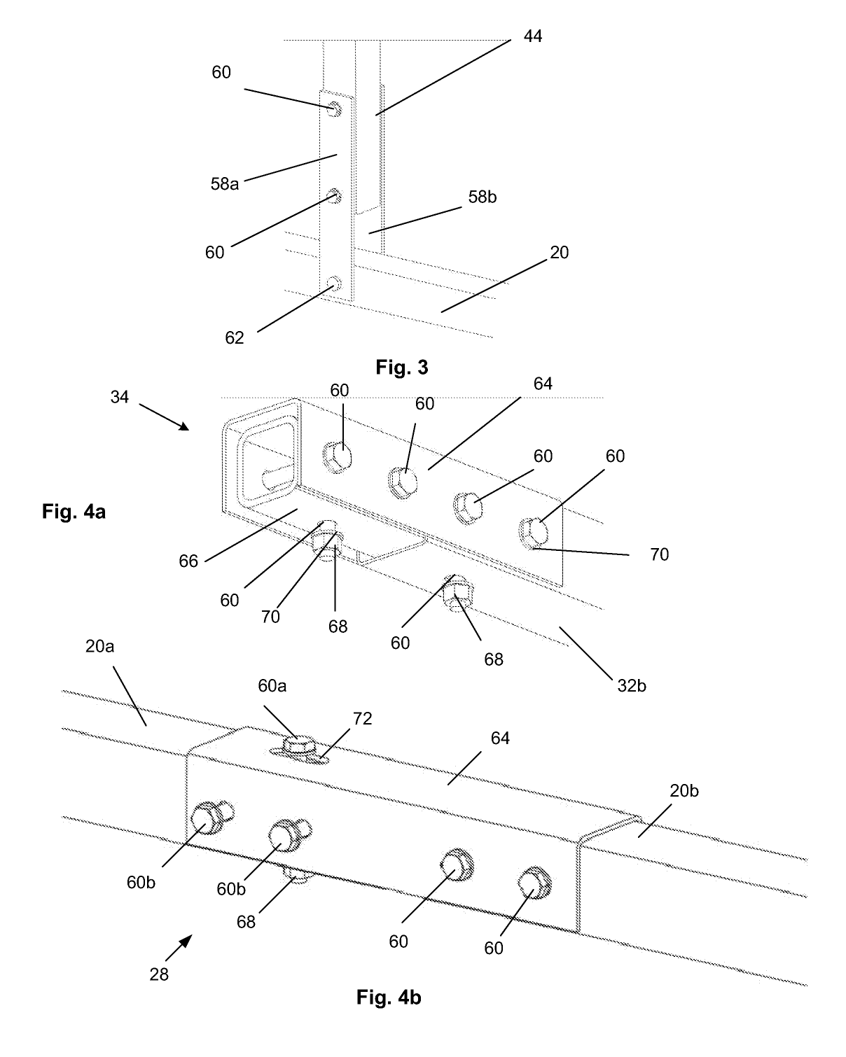

FIG. 3 illustrates that the terminal bottom of each torque arm 44 can be attached to a drive arm first plate 58a and a drive arm second plate 58b. The drive arm plates 58 can be fixedly attached to opposite lateral sides of the torque arm 44, for example, by two securing bolts 60 through each drive arm plate 58 and the respective lateral wall of the torque arm 44. The drive arm first plate 58a can be not directly attached to the drive arm second plate 58b.

The drive line beam 20 can be positioned between the bottom ends of the drive arm first plate 58a and the drive arm second plate 58b. The drive line beam 20 can be attached to the drive arm plates 58 at a rotatable joint. For example, a pin 62 can be positioned through the drive arm plates 58 and the drive line beam 20. The drive line beam 20 can rotate about the pin 62 with respect to the drive arm plates 58.

FIG. 4a illustrates that the torque tube splice 34 can be used to connect adjacent torque sub-tubes 32 (the torque first sub-tube can be positioned in the torque tube splice adjacent to the torque second sub-tube 32b, but is not shown for illustrative purposes). The torque tube splice 34 can have a splice housing 64 and a splice body 66.

The splice housing 64 can be positioned radially exterior to the splice body 66. The splice housing 64 can have a larger internal cross-section perimeter than the external cross-section perimeter of the torque sub-tubes 32. The splice body 66 can have a smaller external cross-section perimeter than the internal cross-section perimeter of the torque sub-tubes 32.

The splice housing 64 can be radially external to the torque sub-tubes 32. The splice body 66 can be radially internal to the torque sub-tubes 32.

The torque first sub-tube can terminate in the first end of the splice housing 64. The torque second sub-tube 32b can terminate in the second end of the splice housing 64. The terminal end of the torque first sub-tube can be spaced apart by a gap within the splice 34 from the adjacent terminal end of the torque second sub-tube 32b.

Laterally extending bolts 60 can extend through both lateral walls of the splice housing 64, respective torque sub-tube 32, and the splice body 66. The splice 34 can have two laterally extending bolts 60, one bolt positioned distal to the other bolt, through each of the respective torque sub-tubes 32 (e.g., 4 lateral bolts total per splice).

Vertically extending bolts 60 can extend through the top wall of the splice housing 64, the respective torque sub-tubes 32, and the splice body 66. The splice 34 can have one vertically extending bolt 60 through each of the respective torque sub-tubes 32 (e.g., 2 vertical bolts total per splice).

The bolts 60 can be fastened and attached to the remaining elements of the splice 34 with nuts 68 and washers 70.

The torque tube splice 34 can rotatably and linearly fix each respective torque tube beam 32 to the splice housing 64 and splice body 66. The splice 34 can have at least one bolt 60 that extends laterally or vertically through and linearly fixes each respective torque tube beam 32 to the splice housing 64 and splice body 66.

FIG. 4b illustrates that the drive line splice 28 can have a splice housing 64. The drive line splice 28 can have a splice body or be absent of a splice body. The splice housing 64 can have one, two or more splice position adjustment slots 72. The splice position adjustment slots 72 can extend in the longitudinal direction. The splice adjustment slots 72 can be, for example, from about 1 in. to about 4 in. long, for example about 2 in. long. The splice position adjustment slots 72 can allow the longitudinal translational adjustment of the drive line first beam 20a with respect to the splice housing 64, (and remainder of the) splice 28, and the drive line second beam 20b during manufacture or assembly of the array 10.

The drive line splice 28 can have one or more adjustment bolts 60a in each adjustment slot 72. For example, FIG. 4b is shown with a single adjustment bolt 60a in a single adjustment slot 72. The adjustment bolt 60a can extend vertically through the drive line first beam 20a. The second adjustment bolt can extend through a second splice position adjustment slot (not shown) and through the drive line second beam (e.g., to also adjust the longitudinal position of the drive line second beam with respect to the drive line splice).

The adjustment bolts 60a can each be attached to a washer 70 and nut 68. During assembly of the array 10, the adjustment bolts 60a can be loose and the drive line beams 20 can be longitudinally adjusted until the drive line beams 20 are at desired positions relative to each other. The adjustment bolts 60a and nuts 68 can then be tightened to longitudinally translationally fix respective drive line beams 20 to the drive line splice 28.

Lateral securing bolts 60b can then be laterally inserted through the splice housing 64 and the drive line first beam 20a. For example, ports through the splice housing 64 and the drive line first beam 20a for passage of the securing bolts 60b can be drilled or otherwise formed after the drive line first beam 20a is in a final longitudinal position with respect to the drive line splice 28 and after the adjustment bolt 60a is fixed by the respective nut 68 to the drive line first beam 20a and the splice housing 64.

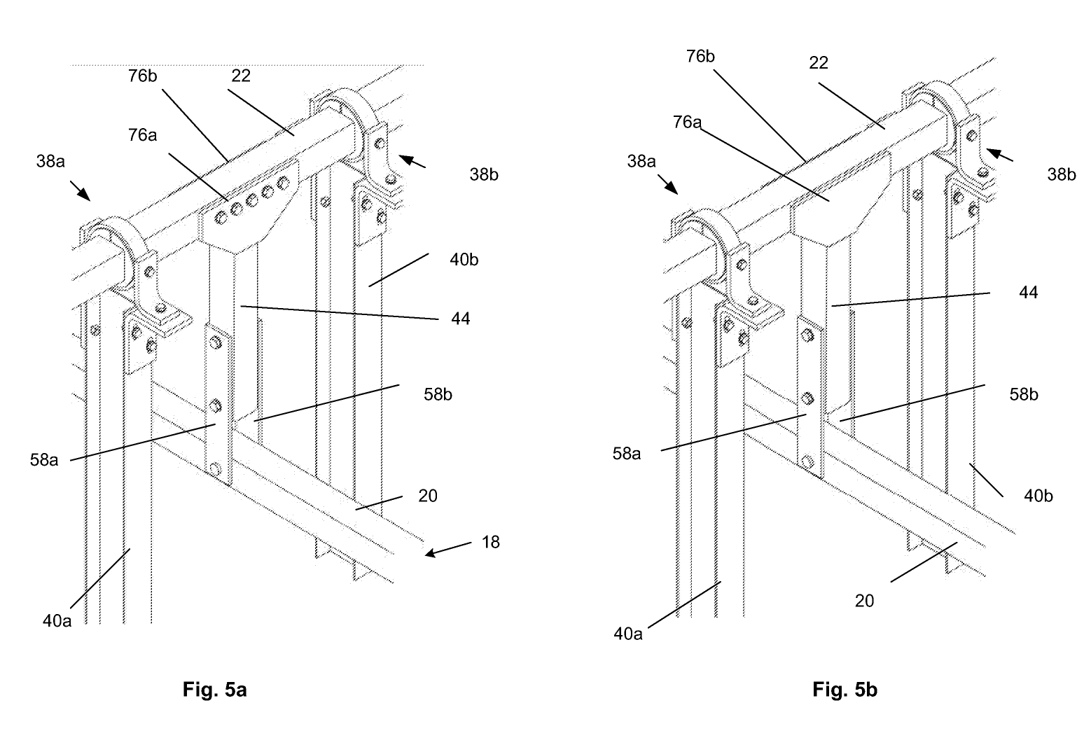

FIG. 5a illustrates that the piers 40 can be laterally spaced in pairs. For example the first pier 40a and the second pier 40b can be at the same longitudinal location with respect to the drive line 18, and equally laterally spaced on opposite sides of the drive line 18.

The piers 40 can be rotatably attached perpendicularly to the torque tubes 22 at a rotating joint, such as gimbal assemblies 38. For example, the first gimbal assembly 38a can be attached to the top terminal end of the first pier 40a, and the second gimbal assembly 38b can be attached to the top terminal end of the second pier 40b. The gimbal assemblies 38 can rotatably join the torque tube 22 to the first and second piers 40a and 40b.

The torque arm 44 can be attached to or be integrated with a front torque plate 76a and a rear torque plate 76b. The front torque plate 76a can be fixed at the bottom end to the front of the torque arm 44 and at the top end to the front of the torque tube 22. The rear torque plate 76b can be fixed at the bottom end to the rear of the torque arm 24 and at the top end to the rear of the torque tube 22.

The torque plates 76 can be rotatably and translatably fixedly attached to the torque tube 22 by a linear, horizontal row of securing bolts extending through the plates and the torque tube, for example about five bolts.

FIG. 5b illustrates that the torque plates 76 can be rotatably and translatably fixedly attached to the torque tube 22 by welds, adhesives, epoxies, or combinations thereof.

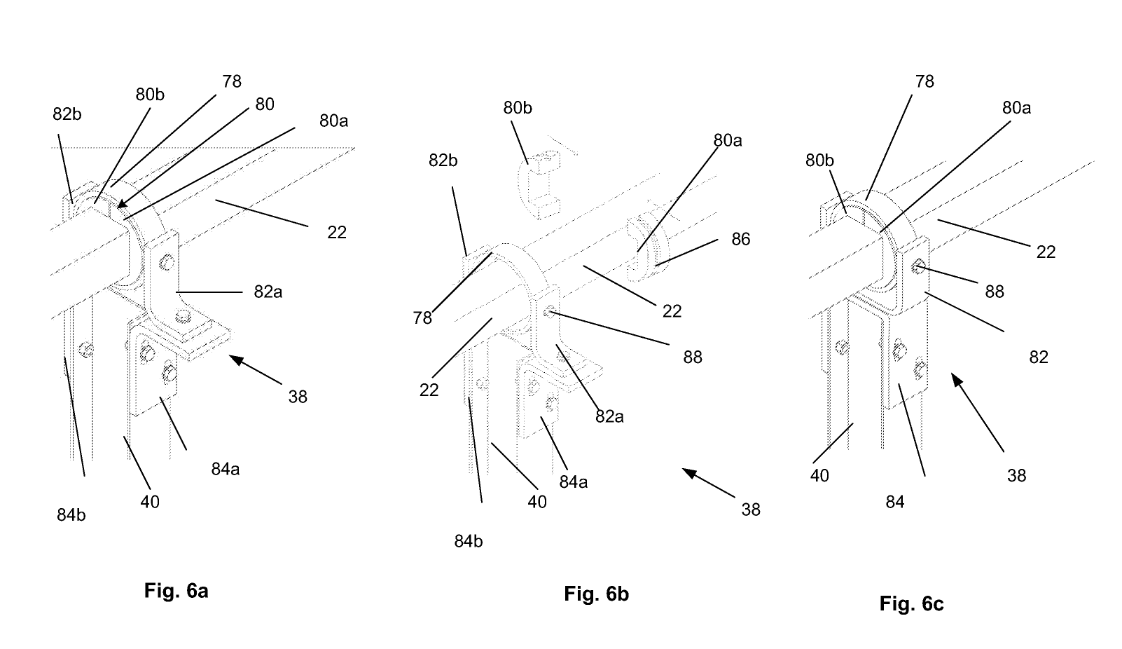

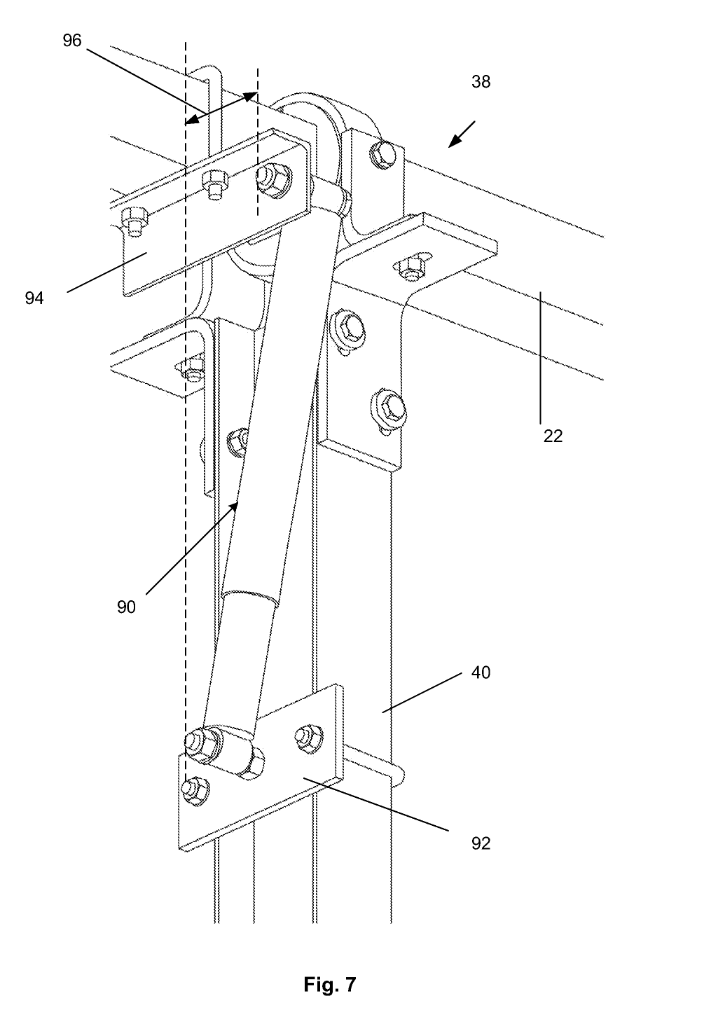

FIG. 6a illustrates that the gimbal assembly 38 can have a gimbal ring 78 or housing. The gimbal ring 78 can be circular. The gimbal ring 78 can be made, for example, from galvanized steel or any other material disclosed herein or combinations thereof. The gimbal ring 78 can rotatably house or attach to a gimbal bearing 80. The bearing 80 can have a port through the bearing that is shaped (e.g., squarely) to match the torque tube 22. The torque tube 22 can extend through the port and be rotationally fixed to the bearing 80.

The gimbal bearing 80 can have a bearing first portion 80a and a bearing second portion 80b. The bearing first and second portions 80a and 80b can each be about half of the bearing 80. For example, the bearing 80 can be split down the middle of the bearing into the bearing first portion 80a and the bearing second portion 80b.

The gimbal bearing 80 can be made from a polymer, for example ultra-high molecular weight polyethylene (UHMWPE). The gimbal bearing 80 can be made from a self-lubricating material, for example UHMWPE. The gimbal bearing 80 can have a coefficient of friction from about 0.10 to about 0.18, for example about 0.14. The bearing 80 can be made from an ultraviolet light resistant polymer that is resistant to degradation from solar exposure.

The gimbal assembly 38 can have gimbal support first and second brackets 82a and 82b. The gimbal support brackets 82 can be L-brackets. The gimbal assembly 38 can have pier support first and second brackets 84a and 84b. The pier support brackets 84 can be L-brackets.

The pier support first and second brackets 84a and 84b can be fixedly attached to the front and back, respectively of the top end of the pier 40. The gimbal support first and second bracket 82a and 82b can be fixedly attached to the top of the pier support first and second brackets 84a and 84b, respectively, and to the front and rear, respectively, of the gimbal ring 78. The gimbal ring 78 can be directly attached to the top terminal end of the pier 40.

Bolts securing the pier support first and second brackets 84a and 84b to the pier 40 can extend through vertical slots in the pier support brackets 84. The pier support brackets 84 can be translated up and down, as needed, to position the gimbal assembly 38 during assembly, before translationally fixing the brackets 84 to the pier 40.

The gimbal ring 78 can have allowances in the form of larger than required gaps and generous tolerances in assembly to aid in field adjustment in the pitch and rotation of the torque tube 22 journalled through the gimbal ring 78. For example, the gimbal ring 78 can accommodate the pier 40 being less than about 10° or less out of plumb (e.g., away from vertical), more narrowly less than about 5° or less out of plumb.

The torque tube 22 can have a square, rectangular, circular, oval, or I-beam cross-section, or variations thereof at different lengths along the torque tube 22.

FIG. 6b illustrates that the bearing 80 can be assembled, as shown by arrows, from the bearing first portion 80a and the bearing second portion 80b. During assembly, the bearing first and second portions 80a and 80b can be inserted into the gimbal ring 78 after the torque tube 22 in inserted in the gimbal ring 78 and the gimbal ring 78 is attached to the pier 40 (e.g., via the gimbal and pier support brackets 82 and 84).

The bearing first and second portions 80a and 80b can be adhered or unadhered to or separate from each other. The bearing first and second portions 80a and 80b can be pressed against each other within the gimbal ring 78 by the compressive forces between the torque tube 22 and the gimbal ring 78.

The bearing 80 can have a bearing track 86, such as an angular track, slot, ridge, or groove that extends circularly around the external perimeter of the bearing 80 that can negatively match tracks, slots, ridges, or grooves in the radially inner surface of the gimbal ring 78. For example, the matched tracks, slots, ridges, grooves, or combinations thereof, can translationally fix, yet allow rotational motion between the bearing 80 and the gimbal ring 78.

The gimbal assembly 38 can have one or more set screws 88, for example positioned on opposite sides (e.g., front and rear) of the gimbal assembly 38. The set screws 88 can attach the gimbal support brackets 82 to the gimbal ring 78. The distal terminal ends of the set screws 88 can extend into the bearing track 86. The bearing track 86 can be configured to accommodate, seat and slidably rotate against the terminal end of the set screw 88 inside the gimbal ring 78.

The gimbal assembly 38 may be disassembled from the torque tube 22 without moving the assembled position of the torque tube 22 in the overall assembly (e.g., relative to the piers 40, or other elements). For example, the gimbal bearing 38 can be removed from the gimbal ring 78 by removing or otherwise unseating the set screws 88, if present. The gimbal bearing first and second portions 80a and 80b can then be dislodged from the ring 78 sequentially or, with sufficient force (e.g., delivered at the seam or split between the portions 80a and 80b) simultaneously.

The bearing 80 can then be tapped out to one side of the gimbal ring 78 by striking the bearing 80 from the opposing side with a hammer and cold chisel or other blunt object. Alternately the gimbal and pier support brackets 82 and 84 can be unbolted and removed from the pier 40 allowing for serviceability.

FIG. 6c illustrates that the gimbal support bracket 82 can be a single U-bracket. The pier support bracket 84 can be a single U-bracket.

FIG. 7 illustrates that a viscous damper or dampener 90, such as a hydraulic or pneumatic shock, can be fixed at a bottom end to the pier 40. The viscous dampener 90 can be fixed at a bottom end to the center of a dampener-pier bracket 92. The dampener-pier bracket 92 can be centered with and attached to the pier 40. The viscous dampener 90 can be fixed at a top end to an offset position on a dampener-torque tube bracket 94. The dampener-torque tube bracket 94 can be centered with and attached to the torque tube 22, The attachment of the top of the viscous dampener 90 to the center of the torque tube 22 when the torque tube is rotated 0° from center (e.g., when the planar faces of the PV modules are horizontal) can be offset by a dampener lever arm 96. The dampener lever arm 96 can be from about 4 in to about 8 in, for example about 6.25 in.

The viscous dampener 90 can have a stroke from about 6 in to about 13 in, for example about 12.69 in. The dampener travel length can be equal to the distance traveled by the damper arm. The dampener 90 can have a stroke of about 6 in to about 10 in, for example about 8.1 in.

Each row can have a viscous dampener 90 attached at one pier 40, each pier 40, at the terminal ends of each wing 24, or combinations thereof.

Any or all elements of the array other than portions of the panels and power cabling from the panels to a collector can be made from metal, such as from hot-dip galvanized steel and anodized aluminum or combinations thereof, for example, structural steel manufactured to ASTM A36, A500, or A992, and galvanization to ASTM A123.

Any elements described herein as singular can be pluralized (i.e., anything described as “one” can be more than one). Any species element of a genus element can have the characteristics or elements of any other species element of that genus. The above-described configurations, elements or complete assemblies and methods and their elements for carrying out the invention, and variations of aspects of the invention can be combined and modified with each other in any combination.

We claim:

1. A solar power tracking system comprising:
an actuator;
a drive line mechanically attached to the actuator, wherein the drive line comprises a first drive line beam, a second drive line beam, and a first splice at least partially between the first drive line beam and the second drive line beam; and
a first photovoltaic (PV) module, and a second PV module, and wherein the first and second PV modules are rotatably attached to the drive line;
wherein the first splice is between the first PV module and the second PV module.

2. The system of claim 1 further comprising: a first pier, and a second pier, wherein the first pier is aligned with the first PV module, and wherein the second pier is aligned with the second PV module, and wherein the first splice is between the first pier and the second pier.

3. The system of claim 1, further comprising:
a first torque arm, wherein a bottom end of the first torque arm is attached to the first drive line beam and a top end of the first torque arm is attached to the first PV module, and
a second torque arm, wherein a bottom end of the second torque arm is attached to the second drive line beam and a top end of the second torque arm is attached to the second PV module, and
wherein when the first torque arm is in a vertical position, the first splice is between the bottom of the first torque arm and the bottom of the second torque arm.

4. The system of claim 1, further comprising a torque arm attached to the drive line and the PV module, and wherein when the torque arm is linearly aligned with the pier, the first splice is between the first pier and the second pier.

5. The system of claim 1, wherein the first PV module comprises a first elongated structural support member, and wherein the first elongate structural support member extends at least the length of all of the PV panels of the first PV module; and wherein the second PV module comprises a second elongated structural support member, and wherein the second elongate structural support member extends at least the length of all of the PV panels of the second PV module; and wherein the system further comprises a first pier and a second pier; and wherein the first elongated structural support member is rotationally attached to the first pier; and wherein the second elongated structural support member is rotationally attached to the first pier.

6. The system of claim 5, wherein the first splice is between the first elongated structural support member and the second elongated structural support member.

7. The system of claim 1, wherein the first drive line beam is rotatable with respect to the second drive line beam about the splice.

8. The system of claim 1, wherein the first drive line beam is rotatably fixed with respect to the second drive line beam at the splice.

9. The system of claim 1, wherein the first PV module comprises an elongated structural support member, and wherein the elongated structural support member is rotatably attached to the first pier.

10. The system of claim 9, further comprising a bearing, wherein the bearing comprises a polymer, and wherein the bearing is configured in at least two portions, and further comprising a housing wherein the bearing is at least partially in the housing.

11. The system of claim 10, wherein the housing is attached to the first pier, and wherein the bearing is rotatably fixed to the elongated structural support member.

12. The system of claim 1, further comprising a control system, wherein the control system comprises a receiver configured to detect data from at least one global positioning satellite, and wherein the control system is configured to activate the actuator, and wherein the system is configured for the actuator

13. A solar power tracking system comprising:
a PV module comprising an elongated structural support member;
a pier;
a bearing, wherein the bearing is rotationally fixed to the elongated structural support member, and wherein the bearing comprises a polymer, and wherein the bearing comprises a bearing first portion and a bearing second portion, and wherein the bearing first portion is unadhered to the bearing second portion; and
a housing, wherein the bearing is in the housing.

14. The system of claim 13, wherein the bearing comprises ultra-high molecular weight polyethylene.

15. The system of claim 13, wherein the housing is circular, and wherein the housing is attached to the top of the pier.

16. A method of making a solar power tracking system comprising:
assembling a drive line, wherein assembling the drive line comprises attaching a first drive line beam to a second drive line beam at a splice;
positioning the drive line adjacent to a first PV module and a second PV module, wherein the splice is between the first PV module and the second PV module; and
attaching the drive line to an actuator.

17. The method of claim 16 further comprising:
securing a first pier in the ground or in a foundation;
securing a second pier in the ground or in a foundation;
wherein positioning the drive line further comprises positioning the first splice between the first pier and the second pier.

18. The method of claim 17, wherein the first pier is aligned with the first PV module, and wherein the second pier is aligned with the second PV module.

19. The method of claim 16 further comprising:
securing a first pier in the ground or in a foundation;
securing a second pier in the ground or in a foundation;
wherein the first pier and the second pier are laterally aligned with the first PV module.

20. The method of claim 16, wherein the PV module comprises an elongated structural support member, and the method further comprises:
securing a first pier in the ground or in a foundation;
attaching a housing to the first pier, wherein the housing holds a bearing;
rotatably fixing the bearing to the structural support member;
removing the bearing from the housing without moving the structural support member with respect to the first pier.
